(19) United States
(12) Patent Application Publication
(10) Pub. No.: US 2008/0089353 A1
(43) Pub. Date: Apr. 17, 2008

(54) SWITCHING DEVICE AND METHOD WITH MULTICHANNEL INPUT QUEUING SCHEME

(75) Inventors: Bohdan DUNETS, Suwon-si (KR); Austin Kim, Seongnamsi (KR)

Correspondence Address: THE FARRELL LAW FIRM, P.C., 333 EARLE OVINGTON BOULEVARD, SUITE 701, UNIONDALE, NY, 11553, US

(73) Assignee: SAMSUNG ELECTRONICS CO., LTD., Suwon-si (KR)

(21) Appl. No.: 11/871,561

(22) Filed: Oct. 12, 2007

(30) Foreign Application Priority Data
Oct. 13, 2006 (KR) 99982/2006

(51) Int. Cl. H04L 12/56

(52) U.S. Cl. 370/415

(57) ABSTRACT

An MIQ packet switch device and packet switching method are provided. The MIQ packet switch device performs cell-based switching of packet data, and includes one or more input queue arrays for buffering cells input through one or more input ports. Each of the one or more input queue arrays includes an input interface for outputting the cells to one or more output ports. The one or more input queue arrays further include a switch matrix for switching and outputting each of the cells transferred by the input interface to a corresponding output port of the one or more output ports. The one or more queue arrays also include a scheduler for receiving descriptor information for cell scheduling from each of the one or more input queue arrays, and creating control information for controlling each of the one or more input queue arrays to selectively output the cells, based on the descriptor information.

### PRIORITY

This application claims priority under 35 U.S.C. §119(a) to an application entitled “Switching Device and Method with Multichannel Input Queuing Scheme” filed in the Korean Intellectual Property Office on Oct. 13, 2006, and assigned Serial No. 2006-0099982, the contents of which are incorporated herein by reference.

### BACKGROUND OF THE INVENTION

1. Field of the Invention

The present invention generally relates to a cell-based switching fabric and method, and more particularly, to a packet switch device and packet switching method using a multichannel input queuing scheme.

2. Description of the Related Art

Cell-based switching technology is widely used for achieving high-speed and high-capacity packet transmission. This is because a cell-based switch can operate at high speeds using synchronous hardware logic. The cell-based switching technology is an important element in an Asynchronous Transfer Mode (ATM) network, a Peripheral Component Interconnect Express (PCI-Express) based system architecture, etc. Since packets arriving at a packet switch are characterized in that they are not scheduled, at least two or more packets may reach the packet switch as different inputs having the same input. The packet switch allows only one of them to be output. However, packets not allowed to be output in a corresponding time slot are queued for next transmission. Queuing is commonly used to improve switch performance by preventing internal blocks from being congested. The packet switch may employ four different queuing schemes, specifically, Input Queuing (IQ), input smoothing, Output Queuing (OQ), and shared buffering.

FIG. 1 illustrates the structure of a packet switch that performs IQ. In the case of IQ, packets arriving at each input port are queued in an input interface 11. The input-queued packets are extracted from input queues, pass through a switching fabric (or switch matrix) 13 according to several algorithms for preventing collisions between packets within the switch matrix 13 or in input and output interfaces, and then are transmitted to the next node. Also, FIG. 2 illustrates the structure of a packet switch that performs OQ in an output interface 21, and FIG. 3 illustrates the structure of a packet switch that performs Combined Input and Output Queuing (CIOQ) in both input and output interfaces 31, 33.

A problem in an input buffer switch with First-In-First-Out (FIFO) input buffers is Head Of Line (HOL) blocking. The HOL blocking is illustrated in FIG. 4. The HOL blocking is a phenomenon in which when outputting a preceding cell 41 is delayed, outputting a following cell 43 that can be output is also delayed. One study reported that the throughput of random uniform traffic in an input buffer switch was lowered to about 58.6% due to the HOL blocking. Here, the throughput is determined by the ratio of the number of actually transmitted cells to the maximum number of cells transmittable through a switch fabric. Fast arbitration schemes for relaxing strict FIFO rules in an input buffer switch may improve throughput in the input buffer switch.

A first attempt to alleviate the HOL blocking is the so-called Virtual Output Queuing (VOQ) scheme. FIG. 5 illustrates the structure of a packet switch that performs VOQ. Referring to FIG. 5, it can be noted that cell #2, the outputting of which is delayed due to the HOL blocking by cell #1 in FIG. 4, can be transmitted in the VOQ packet switch. A second attempt to alleviate the HOL blocking is the so-called window technology, through which the strict FIFO rules in input buffers can be relaxed.

In the present day, cell delay occurring in an IQ packet switch can be optimized by a method in which one or more cells are output from an input buffer in one time slot. This method is used in a packet switch that performs CIOQ, as illustrated in FIG. 3, or in a packet switch that performs IQ by using advanced window technology. However, existing packet switches are problematic in that their structures are very complex because they must operate at a higher speed than a line speed at which packets reach. Further, in the VOQ packet switch it is difficult to optimize mean cell delay time because it outputs one cell from an input buffer in one time slot, and is not practicable due to its high complexity. Further, the IQ packet switch using the window technology not only has a very complex input buffer structure and a very complicated scheduling scheme, but also requires very large window size in order to attain a bandwidth of 100%.

### SUMMARY OF THE INVENTION

The present invention has been made to address at least the above problems and/or disadvantages and to provide at least the advantages described below. Accordingly, an aspect of the present invention provides a packet switch device using a multichannel input queuing scheme, which ensures high packet throughput while operating at line speed, and a packet switching method thereby.

Another aspect of the present invention provides a packet switch device using a multichannel input queuing scheme, which can optimize mean cell delay time while ensuring high packet throughput even with small window size, and a packet switching method thereby.

An additional aspect of the present invention provides a packet switch device using a multichannel input queuing scheme, which employs a fast parallel window-based scheduling scheme with lower complexity than in the prior art, and a packet switching method thereby.

According to one aspect of the present invention, a packet switch device for performing cell-based switching of packet data by using a multichannel input queuing scheme is provided. The device includes one or more input queue arrays for buffering cells input through one or more input ports. Each of the one or more input queue arrays includes an input interface for outputting the cells to one or more output ports. The device also includes a switch matrix for switching and outputting each of the cells transferred by the input interface to a corresponding output port of the one or more output ports. The device further includes a scheduler for receiving descriptor information for cell scheduling from each of the one or more input queue arrays, and creating control information for controlling each of the one or more input queue arrays to selectively output the cells, based on the descriptor information.

According to another aspect of the present invention, there a packet switching method using a multichannel input queuing scheme is provided. Cells input is buffered through one or more input ports in one or more input queue arrays. Descriptor information is transferred by each of the one or more input queue arrays to a scheduler in order to schedule the cells. Control information is created by the scheduler for controlling each of the one or more input queue arrays to selectively output the cells, based on the descriptor information. Each of the cells is switched and output by each of the input queue arrays to a corresponding output port, based on the control information.

### BRIEF DESCRIPTION OF THE DRAWINGS

The above and other objects, features and advantages of the present invention will be more apparent from the following detailed description when taken in conjunction with the accompanying drawings, in which:

FIG. 1 is a block diagram illustrating a structure of a conventional packet switch that performs IQ;

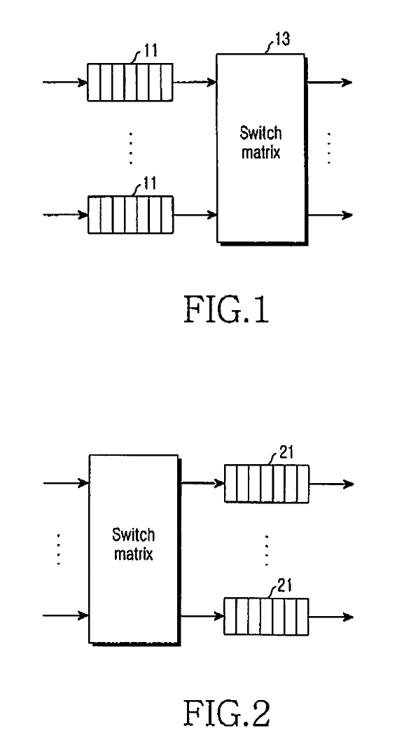

FIG. 2 is a block diagram illustrating a structure of a conventional packet switch that performs OQ;

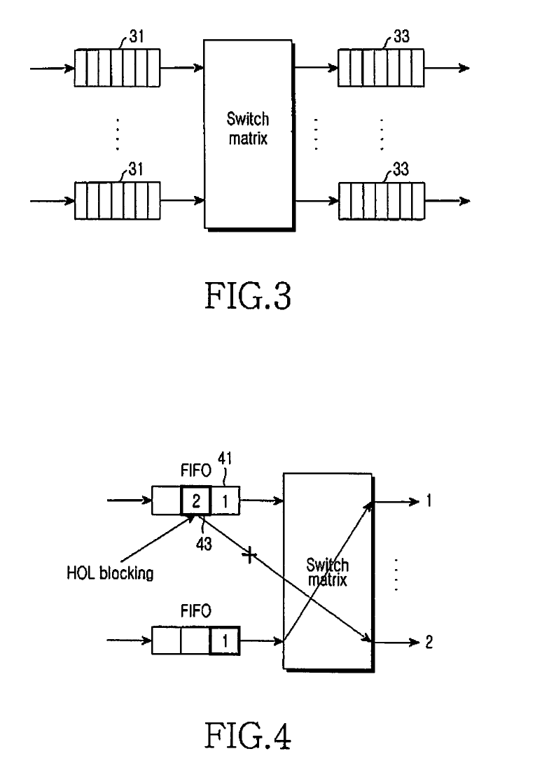

FIG. 3 is a block diagram illustrating a structure of a conventional packet switch that performs CIOQ;

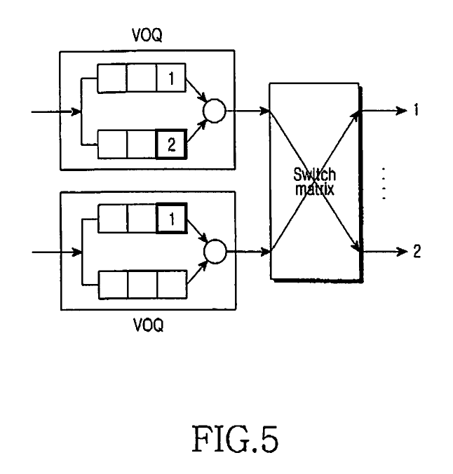

FIG. 4 is a block diagram for explaining an HOL block problem that occurs in conventional packet switches;

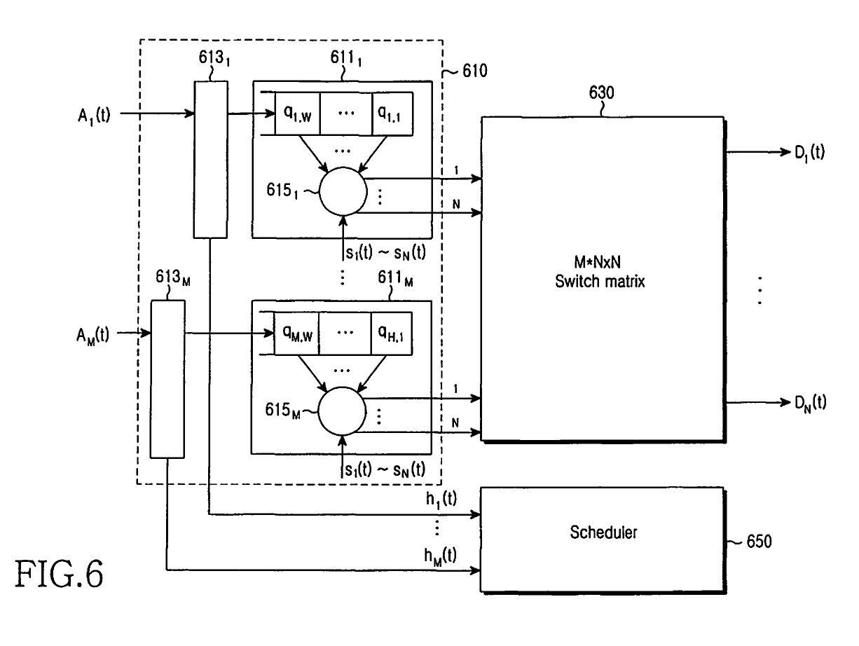

FIG. 5 is a block diagram illustrating a structure of a conventional packet switch that performs VOQ;

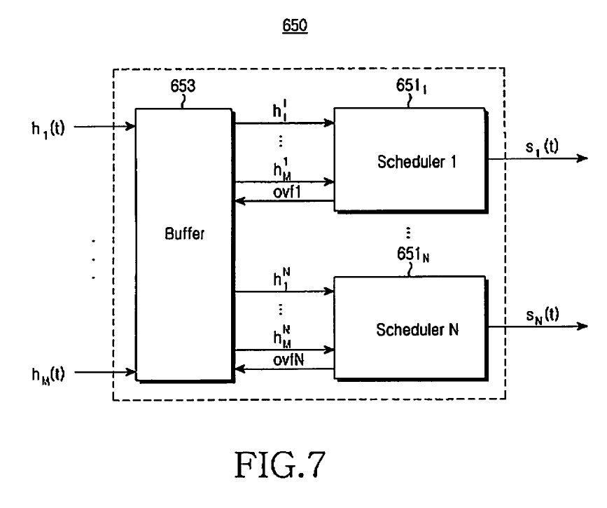

FIG. 6 is a block diagram illustrating a structure of an MIQ packet switch in accordance with an embodiment of the present invention;

FIG. 7 is a block diagram illustrating a structure of a scheduler illustrated in FIG. 6;

FIG. 8 is a block diagram illustrating structures of input queue arrays and a switch matrix illustrated in FIG. 6; and

FIGS. 9 to 11 are graphs illustrating simulation results for mean cell delay time and throughput to be obtained when FPSA is applied in accordance with an embodiment of the present invention.

### DETAILED DESCRIPTION OF THE PREFERRED EMBODIMENTS

Preferred embodiments of the present invention are described in detail with reference to the accompanying drawings. It should be noted that the similar components are designated by similar reference numerals although they are illustrated in different drawings. Detailed descriptions of constructions or processes known in the art may be omitted to avoid obscuring the subject matter of the present invention.

A description is first provided regarding the basic concept of a packet switch using a Multichannel Input Queuing scheme (hereinafter, “MIQ packet switch”).

The MIQ packet switch of the present invention applies an improved scheduling algorithm that uses small window size and yet can ensure high throughput and reduce mean cell delay time. The mean cell delay time means the number of time slots over which one cell waits until it is transmitted to an output port after arriving at an input buffer. Also, the MIQ packet switch of the present invention operates on a cell-by-cell basis. In this MIQ packet switch, a variable length packet is segmented into a plurality of fixed length cells, and the fixed length cells are reassembled into an original packet before they are output. A time slot is divided in units of cell slots, and one cell slot means a time when one cell is transmitted. In the present invention, it is assumed that cells reach an MIQ packet switch in the first cell slot, that is, at the beginning of a time slot, and are output before the end of the time slot.

Further, the scheduling algorithm of the present invention enables parallel calculation of selection matrix elements and buffering in which maximum throughput is obtained even with a small window size, and is implemented in such a manner as to reduce complexity. In the following description, the inventive scheduling algorithm will be referred to as the Fast Parallel window-based Scheduling Algorithm (FPSA). In the present invention, the FPSA is performed through three steps of vertical search, horizontal search, and acceptance and switching. The operation in each step is described in detail below.

The MIQ packet switch of the present invention includes an input interface. The input interface is provided with a plurality of input ports, each of which has an input queue array for buffering externally input cells and a plurality of buffer lines connecting the input queue array with a switch matrix. Each input port has a processor that provides a scheduler with descriptor information so as to perform cell scheduling according to the FPSA. Using the descriptor information, the scheduler creates control information to be applied to the input queue array. Each input queue array receives and buffers one cell in one time slot, and based on the control information, can select cells to be transmitted to output ports, up to the maximum number of the output ports.

A detailed description of the structure of the MIQ packet switch and the operation of the FPSA is provided below.

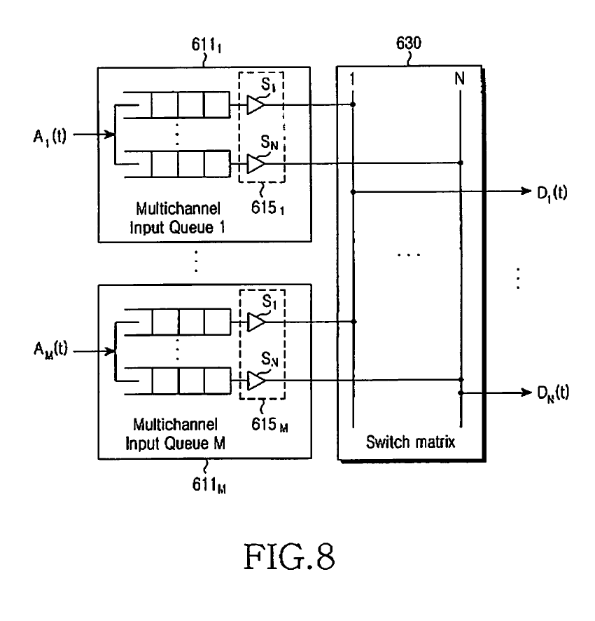

FIG. 6 illustrates the structure of an MIQ packet switch according to an embodiment of the present invention.

The MIQ packet switch illustrated in FIG. 6 corresponds to an M×N packet switch with M input ports and N output ports. In FIG. 6, reference numerals A₁(t) to A_{M}(t) designate input cell signals input through M input ports. D₁(t) to D_{N}(t) designate output cell signals output through N output ports. S₁(t) to S_{N}(t) designate N pieces of control information, each of which is applied to each input queue array to select cells to be output. The MIQ packet switch of FIG. 6 includes an input interface 610 for buffering input cells, a switch matrix 630 for performing cell switching, and a scheduler 650 for applying control information to the input interface 610 to thereby control it to selectively output the cells input through the M input ports to the N output ports in each time slot.

In FIG. 6, the input interface 610 is provided with the M input ports, each of which has an input queue array 611 (611₁ to 611_{M}) for buffering externally input cells and a plurality of buffer lines connecting the input queue array 611 with the switch matrix 630. Each input port has a processor 613 (613₁ to 613_{M}) that provides the scheduler 650 with descriptor information H(t) (h₁(t) to h_{M}(t)) for cell scheduling. The input queue array 611 of each input port receives the control information S(t) (s₁(t) to s_{N}(t)) for cell selection from the scheduler 650 that has received the descriptor information h₁(t) to h_{M}(t), and selectively transmits a maximum of N cells to the switch matrix 630 in one time slot by using the control information s₁(t) to s_{N}(t).

The switch matrix 630 is connected with the N buffer lines of each input queue array 611 in the M input ports, thereby having an M×N switch matrix architecture. However, the total number of cells to be output from the overall input port in one time slot according to cell scheduling is limited to N. Thus, the switch matrix 630 substantially operates as if it is an N×N switch matrix. To this end, each input queue array 611 may be implemented using an element for selectively outputting cells through the N buffer lines according to the control information S(t), for example, a switching element 615 (615₁ to 615_{N}), such as a tri-state buffer element.

The operational conditions of the inventive MIQ packet switch and the FPSA in are described below in detail.

The MIQ packet switch of the present invention has the following six operational conditions:

1. In one time slot, a maximum of N cells can be selected from each input queue array 611 of M input ports (here, N is the number of output ports).

2. In one time slot, N cells in total can be selected from all the input ports.

3. Each output port doesn't require buffering, and it is assumed that the MIQ packet switch has a non-blocking network fabric.

4. In one time slot, one cell can be transmitted to each output port.

5. The scheduler 650 receives descriptor information h₁(t) to h_{M}(t) as information for cell scheduling from the processor 613 of each input port.

6. The input interface 610, the switch matrix 630, and the scheduler operate at packet line speed.

The FPSA of the scheduling algorithm of the present invention operates as follows:

Among variables and parameters for the FPSA operation, t denotes a time slot, Q(t) denotes an input queue array of each input port, W denotes the window size of an input queue array 611, H(t) denotes an array of descriptor information transferred to the scheduler 650 for the time slot t, V(t) denotes a descriptor matrix that represents the array of descriptor information within the range of the window size W, G(t) denotes an selection matrix that represents a column number in the array H(t), and S(t) denotes a switch vector of control information s₁(t) to s_{N}(t) created by the scheduler 650 for each time slot.

Each input queue array is defined by Q(t)=[q_{i,k}] (i=1, 2, . . . , M; k=1, 2, . . . W), and i and k denote a corresponding input port number and a corresponding window number (i.e., cell number). The array of descriptor information is defined by H(t)=[hᵢ], which is expressed by a matrix column of descriptors that the scheduler 650 receives from the processor 613 of each input port in the time slot t. Each descriptor information hᵢ(t) includes an output port number to which a corresponding cell is switched, and hᵢ(t)=0 means that there is no cell to be switched from a corresponding input port to an output port in the time slot t. The descriptor matrix representing the array of descriptor information within the range of the window size W is defined by V(t)=[ν_{i,k}]. With respect to the time slot t and the cell number k of an input queue array, the scheduler 650 expresses the array of descriptor information by ν_{i,k}=hᵢ(t−k+1), and expresses the selection matrix, which represents a column number in the array of descriptor information, H(t), by G(t)=[G_{i,k}].

According to the definitions described above, the MIQ packet switch of the present invention performs the FPSA operation consisting of three steps, that is, vertical search, horizontal search, and acceptance and switching, in each time slot.

Step 1: The vertical search is performed through a vertical selection function defined by V_SEL(V(t), j, k). Using V_SEL(V(t), j, k), the scheduler 650 searches for the kth column element in the descriptor matrix V(t) for an output port number j and a cell number k, and calculates a corresponding column number g_{i,k} of the selection matrix G(t) according to a result of the search. When there is no searched element, the corresponding column number is output as “0”.

Step 2: The horizontal search is performed through a horizontal selection function defined by H_SEL(G(t), j). Using H_SEL(G(t), j), the scheduler 650 searches for a non-zero element in the jth row of the selection matrix G(t), seeks an input port number i and the cell number k corresponding to the element g_{i,k} of the selection matrix G(t), which has been found in the vertical search, according to a result of the search, and then outputs an element sⱼ of the switch vector S(t) for each output port j.

Step 3: The acceptance and switching is performed between each input queue array 611 that has received the element sⱼ of the switch vector S(t), that is, the control information s₁(t) to s_{N}(t), and the switch matrix 630. According to the control information s₁(t) to s_{N}(t), each input queue array 611 outputs a cell of the cell number k to the switch matrix 630 in a time slot t, and the switch matrix 630 transfers the cell to the corresponding output port j. This step is defined by Dⱼ(t)=q_{i,k} for each output port j.

In the FPSA operation, the scheduler 650 can maintain a maximum of N divided queues in each input port, but may consider Q(t)=[q_{i,k] (i=}1, 2, . . . , M; k=1, 2, . . . , W; W is window size) as a single input queue array for simplification. In each time slot t, cells are stored in the input queue array Q(t), and an array of descriptor information, H(t), is transferred to the scheduler 650. For each time slot, the scheduler 650 creates a switch vector S(t)=[sⱼ] (j=1, 2, . . . , N; sⱼ={i, k}; i is an input port number; j is an output port number; k is a cell number in an input queue array) as control information for cell scheduling, and outputs it to each input port array. According to the control information, each input port array transfers a corresponding cell to the switch matrix via a buffer line selected from among the N buffer lines, and the switch matrix switches and outputs the cell transferred by each input port array to a corresponding output port.

In the aforementioned embodiment, all elements of the selection matrix G(t) may be calculated in parallel by, for example, an N×W vertical selection function. Also, all elements of the switch vector S(t) may be calculated in parallel by, for example, an N horizontal selection function. Such parallel calculations enable the vertical and horizontal search steps (steps 1 and 2) in the FPSA to be performed in one step.

The structures of the input interface 610, the switch matrix 630, and the scheduler 650, which operate according to the FPSA are described in detail below.

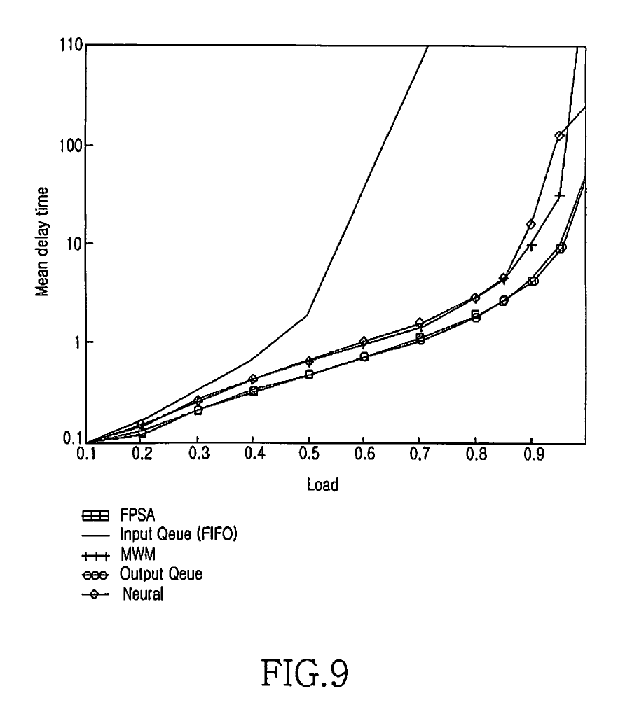

FIG. 7 illustrates the structure of the scheduler 650 shown in FIG. 6.

The scheduler 650 of FIG. 7 is configured in such a manner as to efficiently perform the FPSA even with small window size W. As illustrated in FIG. 7, the scheduler 650 includes first to Nth scheduler sections 651₁ to 651_{N} corresponding one-to-one to N output ports, and an input buffer 653 for temporarily storing descriptor information h₁(t) to h_{M}(t) transmitted from a processor 613₁ to 613_{M} of each input port. The input buffer 653 separates the received descriptor information h₁(t) to h_{M}(t) into N divided descriptor vectors h₁¹ to h_{M}¹, . . . , h₁^{N} to h_{M}^{N}, and stores the descriptor information H₁(t) to h_{M}(t) in an overflow mode. Each of the first to Nth scheduler sections 651₁ to 651_{N} performs cell scheduling for one output port, based on each of the descriptor vectors h₁¹ to h_{M}¹, . . . , h₁^{N} to H_{M}^{N}. The first to Nth scheduler sections 651₁ to 651_{N} transmit overflow signals ovf1 to ovfN to the input buffer 653 when an overflow occurs. Since the first to Nth scheduler sections 651₁ to 651_{N} operate independently, an overflow occurring in one scheduler section has no effect on other scheduler sections.

The size of the buffer 653 in the scheduler 650 is dependent on the window size W of the scheduler 650. An increase in the window size of the scheduler 650 brings a decrease in the size of the buffer 653, and vise versa. Thus, there is a need for an optimal combination of window size and buffer size, which minimizes the gate count of the scheduler in the MIQ packet switch. For example, experiments have shown that the optimum window size of the MIQ packet switch, which ensures a throughput of 100%, is W=8 when the number of input ports, M, and the number of output ports, N, are equally 16.

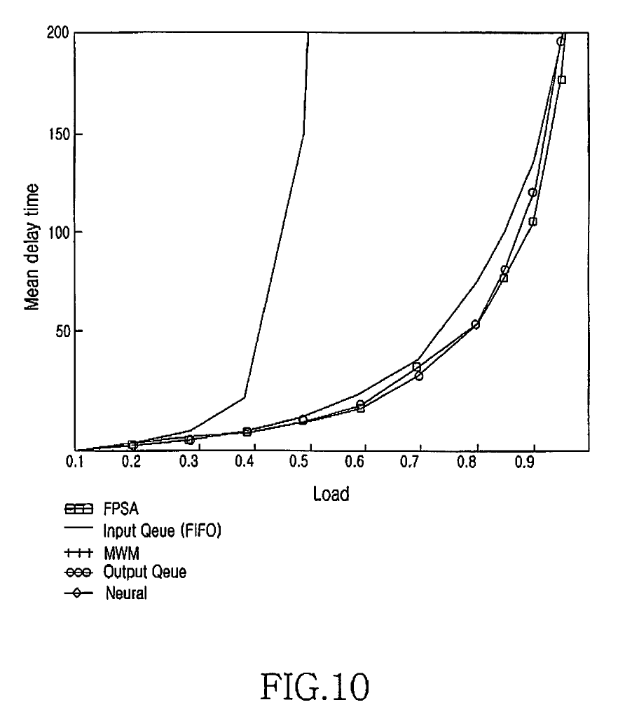

FIG. 8 illustrates the structures of the input queue array 611₁ to 611_{M} and the switch matrix 630, shown in FIG. 6.

Each input queue array 611₁ to 611_{M} of FIG. 7 must select a maximum of N cells in one time slot according to the FPSA. The input queue arrays 611₁ to 611_{M} apply multiple output to the VOQ scheme so as to implement the MIQ scheme of the present invention. In each input queue array 611₁ to 611_{M}, input cells are distributed in an FIFO buffer according to the VOQ scheme, and are selected from the FIFO buffer according to a switch vector S(t)=[sⱼ]. As illustrated in FIG. 8, each input queue array 611₁ to 611_{M} is connected with the output of a corresponding multichannel queue through a tri-state buffer 615₁ to 615_{M}. The switch matrix 630 has a bus structure in which N buffer lines of each input queue array 611₁ to 611_{M} are connected with output ports 1 to N respectively. Thus, a maximum of N cells can be selected from all the input queues in one slot time, as a result of which the bus count of the switch matrix 630 is N, and an N×N switch matrix can be used.

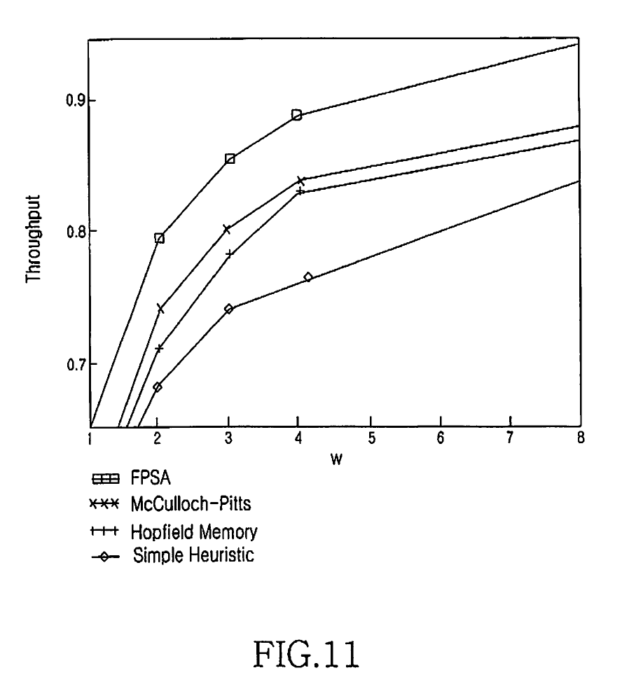

Reference will now be made to performance simulation results of the MIQ packet switch and the FPSA, with reference to FIGS. 9 to 11. A description is provided based on complexity, mean cell delay time, and throughput. FIGS. 9 to 11 illustrate simulation results of mean cell delay time and throughput when the FPSA is applied according to an exemplary embodiment of the present invention.

Algorithm Complexity

In computing the complexity of the FPSA, the maximum number of operations to be accomplished in the overall algorithm execution is considered. Suppose that the complexity of the FPSA is L, L can be calculated by Equation (1):

L=N·W·L_{V}_{_{—}}_{SEL}+N·L_{H}_{_{—}}_{SEL} (1)

In Equation (1), L_{V}_{_{—}}_{SEL} denotes the complexity of a vertical selection function V_SEL(V(t), j, k) in step 1 of the FPSA operation, and L_{H}_{_{—}}_{SEL} denotes the complexity of a horizontal selection function H_SEL(G(t), j) in step 2 of the FPSA operation. The complexities of the vertical and horizontal selection functions depend on a selected algorithm. In general, the vertical and horizontal selection functions may be selected as given by Equation (2):

L_{V}_{_{—}}_{SEL}=log₂ M, L_{H}_{_{—}}_{SEL}=log₂ W (2)

The total number of operations required for executing the FPSA is given by Equation (3):

L=N·W·log₂ M+N·log₂ W (3)

According to the characteristics of the FPSA, a column number g_{i,k} of the selection matrix G(t) and an element sⱼ of the switch vector S(t) can be calculated in parallel. By applying this parallel calculation, the algorithm complexity of the FPSA can be reduced. When the FPSA is implemented as hardware, window size W can be substantially reduced to around the number of input ports, M. Thus, the complexity of the FPSA approximates to that of an MIQ N×N switch.

Mean Cell Delay Time

FIG. 9 illustrates the mean cell delay time of an MIQ packet switch with N=M=16 for uniform Bernoulli arrival, and FIG. 10 illustrates the mean cell delay time of an MIQ packet switch with N=M=16 for uniform Bernoulli arrival having a cell burst length of 16.

The mean cell delay time is determined by the number of time slots over which a cell waits until it is transmitted to an output port after arriving at an input buffer. In computing the mean cell delay time, 0 input queue and switch matrix delay have been assumed. Simulations for uniform Bernoulli arrival and burst cell arrival were conducted during 10,000 time slots. As a result of this, the window size for uniform Bernoulli arrival was selected as 1024 so as to ensure a throughput of 100%. As for simulation conditions, it was assumed that each input port has an input queue with a size of 1024 cells, and switch size is M=N=16.

FIG. 9 illustrates the mean cell delay time of the FPSA for uniform Bernoulli arrival with a mean input cell arrival rate of 1. Referring to FIG. 9, it an be noted that an MIQ packet switch using the FPSA has substantially the same mean cell delay time as that of an OQ packet switch. FIG. 9 also illustrates performance simulation results of an IQ packet switch with FIFO queues, an IQ VOQ packet switch using an NWM scheduling algorithm, and an IQ packet switch using a window-based neutral scheduling algorithm. In a burst traffic model, each input experiences active and idle intervals during distributed intervals. During the active interval, cells with the same output continuously reach in consecutive time slots. The probability that an active period or an idle period ends in one time slot is fixed. The active periods or idle periods are geometrically distributed. It should be noted that an environment including at least one cell is assumed in one active period. The active period is generally called a “burst”.

FIG. 10 illustrates the mean cell delay time of the FPSA for uniform burst arrival with a burst length of 16 cells. It can be noted that the MIQ packet switch using the FPSA has substantially the same mean cell delay time as that of the OQ packet switch.

Throughput

FIG. 11 illustrates the throughput of an MIQ packet switch with N=M=16 for uniform Bernoulli arrival.

The throughput is the ratio between the total number of cells transmitted to an output interface and the total number of cells arriving at an input interface. It is essential to measure the possibility of cell loss in input queues. For uniform Bernoulli arrival with a mean input cell arrival rate of 1, simulations were conducted during 10,000 time slots. As for simulation conditions, it was assumed that each input port has an input queue with a size of 1024 cells, and switch size is M=N=16. A final object of a cell scheduling algorithm is to reach the maximum throughput. FIG. 11 illustrates the throughputs of the FPSA, window-based neutral algorithms (e.g., McCulloch-Pitts, Hopfield Memory), and a simple learning algorithm as a function of window size W. Referring to FIG. 11, it can be noted that the throughput monotonously increases as the window size increases. The FPSA of the present invention provides better throughput than other window-based scheduling algorithms by using the multichannel input queuing scheme. The simulation results show that a switch throughput of 100% may be achieved by a large W value in the proposed FPSA. This is common to all window-based scheduling algorithms. Also, analyses on the FPSA show that when the window size is small, a scheduler overflows, and thus switch throughput is limited. Thus, it is obvious that the MIQ packet switch is used in order to achieve a throughput of 100% even with small window size while removing scheduler overflow. The MIQ packet switch of the present invention performs the FPSA with small window size. A combination of window size and scheduler buffer size must be optimized in such a manner as to minimize MIQ scheduler gate count. The simulation results of FIG. 11 show that a throughput of 100% can be achieved with N=M=16 and window size W=8 in the MIQ packet switch of the present invention.

As described above, the present invention provides an MIQ packet switch and a cell scheduling algorithm, which ensure high throughput even with small window size, reduce mean cell delay time to as low as that of an existing OQ scheme, and operate at packet line speed but still reduce complexity.

While the invention has been shown and described with reference to certain preferred embodiments thereof, it will be understood by those skilled in the art that various changes in form and details may be made therein without departing from the spirit and scope of the invention as defined by the appended claims.

What is claimed is:

1. A packet switch device for performing cell-based switching of packet data using a multichannel input queuing scheme, the device comprising:
one or more input queue arrays for buffering cells input through one or more input ports, each of the one or more input queue arrays comprising:
an input interface for outputting the cells to one or more output ports;
a switch matrix for switching and outputting each of the cells transferred by the input interface to a corresponding output port of the one or more output ports; and
a scheduler for receiving descriptor information for cell scheduling from each of the one or more input queue arrays, and creating control information for controlling each of the one or more input queue arrays to selectively output the cells, based on the descriptor information.

2. The packet switch device as claimed in claim 1, wherein each of the one or more input queue arrays receives and buffers one cell in one time slot.

3. The packet switch device as claimed in claim 1, wherein each of the one or more input queue arrays selectively outputs a maximum number of cells corresponding to a number of the one or more output ports in one time slot according to the control information.

4. The packet switch device as claimed in claim 1, wherein the input interface outputs as many of the cells as a number of the one or more output ports through all the one or more input queue arrays according to the control information.

5. The packet switch device claimed in claim 1, wherein each of the one or more input queue arrays further comprises a switching element for selectively switching and outputting the cells according to the control information.

6. The packet switch device as claimed in claim 1, wherein the input interface, the switch matrix, and the scheduler operate at a line speed of the packet data.

7. The packet switch device as claimed in claim 1, wherein the scheduler comprises:
a plurality of scheduler sections, each of which corresponds to each of the one or more output ports; and
an input buffer for receiving the descriptor information from the input interface and temporarily storing the received descriptor information.

8. The packet switch device as claimed in claim 7, wherein each of the plurality of scheduler sections performs cell scheduling for a single output port.

9. The packet switch device as claimed in claim 7, wherein each of the plurality of scheduler sections operates independently.

10. The packet switch device as claimed in claim 7, wherein each of the plurality of scheduler sections transmits a specific overflow signal to the input buffer when overflow occurs.

11. The packet switch device as claimed in claim 1, wherein each of the one or more input queue arrays can simultaneously output one or more cells of the input cells, and further comprises a switching element for selecting a cell to be output from among the cells according to the control information.

12. The packet switch device as claimed in claim 11, wherein the switching element comprises a tri-state buffer.

13. A packet switching method using a multichannel input queuing scheme, the method comprising the steps of:
buffering cells input through one or more input ports in one or more input queue arrays;
transferring, by each of the one or more input queue arrays, descriptor information to a scheduler in order to schedule the cells;
creating, by the scheduler, control information for controlling each of the one or more input queue arrays to selectively output the cells, based on the descriptor information; and
switching and outputting, by each of the one or more input queue arrays, each of the cells to a corresponding output port, based on the control information.

14. The packet switching method as claimed in claim 13, wherein, in the step of buffering the cells, one cell is received and buffered in one time slot.

15. The packet switching method as claimed in claim 13, wherein each of the one or more input queue arrays selectively outputs a maximum number of cells corresponding to a number of output ports in one time slot according to the control information.

16. The packet switching method as claimed in claim 13, wherein an input interface, a switch matrix, and a scheduler operate at a line speed of packet data.
